(19) United States
(12) Patent Application Publication
(10) Pub. No.: US 2009/0013121 A1
(43) Pub. Date: Jan. 8, 2009

(54) USB COMPUTER SWITCHING DEVICE

(76) Inventor: William Nguyen, Lake Elsinore, CA (US)

Correspondence Address: PASSE' INTELLECTUAL PROPERTY, LLC, 1717 BRASSFIELD RD., RALEIGH, NC, 27614, US

(21) Appl. No.: 12/202,288

(22) Filed: Aug. 31, 2008

Related U.S. Application Data
(63) Continuation-in-part of application No. PCT/US08/67229, filed on Jun. 17, 2008.
(60) Provisional application No. 60/944,513, filed on Jun. 17, 2007.

(51) Int. Cl. G06F 13/00

(52) U.S. Cl. 710/316

(57) ABSTRACT

The present invention describes a device and circuit for attaching at least two computers to a one or more computer peripheral such as a projector in a classroom situation. The peripheral can be switched easily between the computers without difficult toggling by means of a button which activates a relay between the two computers. A default position indicates the position the switch can start in.

This application is a continuation-in-part of PCT application number PCT/US08/67229 filed on Jun. 17, 2008 which claims priority from U.S. provisional application No. 60/944,513 filed on Jun. 17, 2007.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to computer switching devices. In particular, the invention relates to a device for switching a computer peripheral from one computer to another.

2. Description of Related Art

It is common place in classrooms and other large lecture auditoriums to have two computers hooked up for the lecturer to use. Many Smart Classrooms in university settings have both a PC available as well as a Mac based computer since professors and lecturers all have their particular preferences. Peripherals such as a keyboard are used by the lecturer and fed by the computers to aid in the lecture. Unless the auditorium also wants a duplicate keyboard or for that matter any other peripheral to be used, some manner of switching must be used. Current computer switching devices tend to be expensive and difficult to use. Further, since multiple buttons must be pushed or toggled, there is room for computer problems as well as user issues in dealing with the multiple choices.

In U.S. Pat. Nos. 6,622,195 and 6,308,239 there is disclosed a device for attaching a plurality of devices to multiple hosts through a single USB port. In U.S. Pat. No. 6,993,620 there is also described a similar device for connecting multiple peripherals. The device involves associating at least one USB device with a first user and at least another USB device with a second user, assigning the first user to a first USB port, assigning the second user to a second USB port and permitting the first user to temporarily assume control of the computer system through the first USB port for operation of the at least one USB device while blocking the second user from access to the computer system.

It is clear that there is no simple to use simply constructed device that solves the problems of the Smart Classroom.

### BRIEF SUMMARY OF THE INVENTION

The present invention solves the problems of the above disclosed Smart Classroom. It provides a switching means for attaching multiple computers to a single device such as a projector especially in a classroom situation. It has been discovered that the problems are overcome by providing a switching means that connects to a first and second computer and also to a single peripheral device wherein the user may switch from a default computer to a second computer by merely throwing a switch.

In one embodiment the present invention is a switching device for connecting a computer peripheral to share between at least two computers comprising:
a) a first and second type B USB port designed to connect a first and second computer;
b) a type A USB port designed to attach a computer peripheral;
c) a control cable comprising a switching means with an open and closed position;
   wherein the switching means transfers connection of the type A USB port between the first type B USB port and the second type B port by switching the switching means between the open and closed position.

### BRIEF DESCRIPTION OF THE DRAWINGS

FIG. 1 is a schematic diagram of an embodiment of the present invention.

### DESCRIPTION OF THE PRESENT INVENTION

The present invention is a USB switching device that allows the user to have at least two computers share a single USB A port designed to attach one or more peripheral. Thus, a single control switch of the present invention means a user can switch the peripheral attached to the USB port seamlessly between computers without further software or hardware additions to the computer system.

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “and an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

The drawings featured in the FIGURE are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

The device of the present invention comprises at least 3 ports. The first port connects to a first host computer, the second port connects to a second host computer and lastly, there is a third port that accepts a single peripheral device. The first and second ports are USB type B ports while the third port is a USB type A port. The user of the present device can switch from the first or second port using a control cable that has a switching means (either analog or digital) with either an open or closed position. One embodiment of the switching means comprises a button on the control cable that activates a relay or relays between the open and closed position. In another embodiment, when the switching means is in the open position, the first port is the default position. That is, while the control wires are not connected the first port is connected to the third port and its peripheral. When the switching means is in the closed position, the control cables are connected with each other and the device switches to the second port thus connecting the computer connected to that port to the peripheral. As long as the switching means is in the closed position, the second computer is connected to the peripheral. In other embodiments a device for detecting which computer is on is connected to the relay and automatically switches the peripheral to the computer which is on or in other cases the last to be plugged into the device of the present invention. In one embodiment there are two indicator lights, for example LEDs that indicate which port (first or second) is connected to the peripheral and active. In yet another embodiment there is a relay controlled by the control cable that when the control cable is activated automatically opens and closes the connection between the two type B ports. The relay also controls two LED indicator lights such that when one computer is selected the relay also powers a corresponding LED indicator light. By introducing a resistor in the circuit, an LED can be used on the same circuit as the computers and peripherals. The actual resistance of the resistor will depend on the LED but one skilled in the art could add the appropriate resistor and indicator light in view of this disclosure. The tremendous advantage of this device over other devices is that other devices require the user to cycle or toggle through button presses to find the right port or where multiple peripherals are present to toggle through multiple devices. By matching the present device to one peripheral and two computers, the longstanding disadvantages of prior art switching devices for use in the Smart Classroom are avoided. In one embodiment there are multiple connectors for switching between a multiplicity of computers (as many as desired) this is accomplished by the addition of more computers and additional switches.

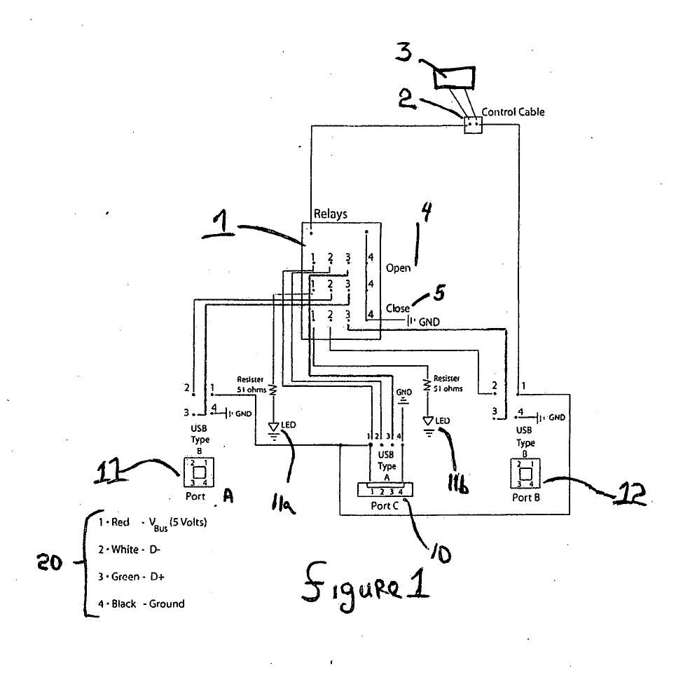

The drawing in FIG. 1 of the present invention shows a schematic of an embodiment of the invention. The switching means in this embodiment is a set of relays 1 controlled by a control cable 2 and wherein the control cable 2 activates the relays via a button 3 on the control cable. The relay 1 has open positions 4 and closed positions 5, which switch between two separate positions. The default position of the relay is to connect port C 10, a Type A USB port to Port A 11, a first type B USB port. The other switched position switches port C 10 from connection to port A 11 to other type B USB port C 12. Appropriate grounding of the circuit is also shown. Further, shown are LED indicator lights 11a and 12a corresponding to when the circuit is connected to port A 11 and port B 12 respectively to the type A port C 10. The diagram code 20 indicates wire color coding and indicates what each respective numbered wire (1-4) is in the particular embodiment shown. It is clear that one would use a separate device of the present invention for each peripheral attached between computers thus giving the user the advantage of only switching the desired device without cumbersome toggling. The present device is thus limited to the 3 ports indicated in the description and claims of the present invention. By placement of the button near the peripheral to be controlled or other convenient place, the user can easily make quick changes without problems.

The above description and accompanying drawing is not intended to be limiting. Substitutions and other embodiments of the present invention are within the skill of the art in view of the disclosure and drawing. Accordingly, the claims should be interpreted with that scope in mind.

What is claimed is:

1. A switching device for connecting a computer peripheral to share between at least two computers comprising:
a) a first and second type B USB port designed to connect a first and second computer;
b) a type A USB port designed to attach a computer peripheral;
c) a control cable comprising a switching means with an open and closed position;
wherein the switching means transfers connection of the type A USB port between the first type B USB port and the second type B port by switching the switching means between the open and closed position.

2. A switching device according to claim 1 wherein there is a computer peripheral attached to the type A USB port and at least one computer attached to one of the first and second type B USB port.

3. A switching device according to claim 1 wherein there is a manual switch which acts as the switching means.

4. A switching device according to claim 1 wherein the switching device automatically switches to whichever port a computer is plugged into last.

5. A switching device according to claim 1 which switches to the first or second port by detecting which port has a computer actively sending data through the computer port.

6. A switching device according to claim 1 wherein the control cable controls a switching relay having an open and closed position and when activated switches connection of the type A port between the two type B ports.

7. A switching device according to claim 1 which further comprises Type A and type B ports sufficient for switching a plurality of peripheral devices.

8. A switching device according to claim 1 which further comprises additional ports and switches to switch between more than two computers.

9. A switching device according to claim 1 which further comprises switches and ports to switch between a plurality of peripherals and more than two computers.
